(19) United States
(12) Patent Application Publication
(10) Pub. No.: US 2009/0211228 A1
(43) Pub. Date: Aug. 27, 2009

(54) HIGH PERFORMANCE LIQUID FUEL COMBUSTION GAS GENERATOR

(75) Inventor: Donald L. Mittendorf, Mesa, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/828,831

(22) Filed: Jul. 26, 2007

Related U.S. Application Data
(60) Provisional application No. 60/894,342, filed on Mar. 12, 2007.

(51) Int. Cl. F02K 9/42

(52) U.S. Cl. 60/258

(57) ABSTRACT

A gas generation system includes a fuel source, an oxidizer source, and a combustion chamber. The fuel source is operable to supply a flow of a lithium fuel, and the oxidizer source is operable to supply a flow of a fluorinated carbon oxidizer. The combustion chamber is coupled to receive the flow of lithium fuel and the flow of the fluorinated carbon oxidizer and, upon receipt thereof, supplies a combustion gas. The combustion chamber is formed, at least partially, of a carbon material.

### CROSS-REFERENCES TO RELATED APPLICATIONS

This application claims the benefit of U.S. Provisional Application No. 60/894,342, filed Mar. 12, 2007.

### TECHNICAL FIELD

The present invention relates to liquid combustion gas generators and, more particularly, to a liquid combustion gas generator rocket motor with improved performance.

### BACKGROUND

Liquid fuel combustion gas generators are used in rockets, missiles, interceptors, and various other vehicles and environments. For example, liquid fuel combustion gas generators may be used to generate combustion gas for both vehicle propulsion and direction control for missiles, munitions, and various spacecraft. Liquid fuel combustion gas generators could also be used to generate propellant gas to drive, for example, a gas turbine of either an airborne or earthbound backup power system. No matter the particular end-use system, a liquid fuel combustion gas generator typically includes a liquid fuel source, a liquid oxidizer source, and a vessel that defines a combustion chamber. The liquid fuel and liquid oxidizer are pumped, or otherwise delivered, to the combustion chamber. The fuel and oxidizer react within the combustion chamber and generate high-energy gas. Depending upon the particular end-use system in which the liquid fuel combustion gas generator is installed, the generated gas may be supplied, or at least selectively supplied, to one or more thrust nozzles to propel a vehicle and/or to control the pitch, yaw, roll or spin rate and other dynamic characteristics of a vehicle in flight.

Liquid fuel gas generators are used with numerous rocket, missile, and other projectile applications, because these types of generators exhibit relatively long ranges. However, these types of generators also exhibit relatively low precision. Moreover, many liquid fuel gas generators are constructed of materials that may not be completely compatible with the combustion gas chemistry. One alternative to liquid fuel gas generators is solid fuel gas generators. However, these types of generators typically exhibit relatively high precision and relatively short range.

Hence, there is a need for a gas generator system that exhibits the desirable attributes of both the liquid propellant and solid propellant rockets. That is, a gas generator system that exhibits relatively long range and relatively high precision. The present invention addresses at least this need.

### BRIEF SUMMARY

In one embodiment, and by way of example only, a gas generation system includes a fuel source, an oxidizer source, and a combustion chamber. The fuel source is operable to supply a flow of a lithium fuel, and the oxidizer source is operable to supply a flow of a fluorinated carbon oxidizer. The combustion chamber is coupled to receive the flow of lithium fuel and the flow of the fluorinated carbon oxidizer and, upon receipt thereof, supplies a combustion gas. The combustion chamber is formed, at least partially, of a carbon material.

In another exemplary embodiment, a liquid rocket includes a fuel source, an oxidizer source, a combustion chamber, a thrust nozzle, a fuel modulation valve, and an oxidizer modulation valve. The fuel source is operable to supply a flow of a lithium fuel, and the oxidizer source is operable to supply a flow of a fluorinated carbon oxidizer. The combustion chamber is coupled to receive the flow of lithium fuel and the flow of the fluorinated carbon oxidizer and, upon receipt thereof, to supply a combustion gas. The combustion chamber is formed, at least partially, of a carbon material. The thrust nozzle is coupled to, and is in fluid communication with, the combustion chamber to receive the combustion gas therefrom and generate a thrust. The fuel modulation valve is disposed between the fuel source and the combustion chamber and is operable to selectively modulate the flow of the lithium fuel to the combustion chamber. The oxidizer modulation valve is disposed between the oxidizer source and the combustion chamber and is operable to selectively modulate the flow of the fluorinated carbon oxidizer to the combustion chamber.

In still another exemplary embodiment, a thrust control system includes a fuel source, an oxidizer source, a combustion chamber, a fluidic amplifier, and a fluidic diverter valve. The fuel source is operable to supply a flow of a lithium fuel, and the oxidizer source is operable to supply a flow of a fluorinated carbon oxidizer. The combustion chamber is coupled to receive the flow of lithium fuel and the flow of the fluorinated carbon oxidizer and, upon receipt thereof, to supply a combustion gas. The combustion chamber is formed, at least partially, of a carbon material. The fluidic amplifier has a fluid inlet port and at least two fluid outlet ports. The fluid inlet is in fluid communication with the combustion chamber to receive combustion gas therefrom. The fluidic diverter valve includes a housing and a valve element. The housing has a first fluid inlet port, a second fluid inlet port, a first fluid outlet port, a second fluid outlet port, and a valve element cavity formed therein. The first fluid inlet port couples a first one of the fluidic amplifier fluid outlets in fluid communication with the valve element cavity. The second fluid inlet port couples a second one of the fluidic amplifier fluid outlets in fluid communication with the valve element cavity. The first and second fluid outlet ports are each in fluid communication with the valve element cavity. The valve element is disposed within the valve element cavity, and is moveable in response to combustion gas flow through the inlet ports to move between at least a first position, in which at least a portion of the valve element substantially seals the first fluid outlet port, and a second position, in which at least a portion of the valve element substantially seals the second fluid outlet port.

Other desirable features and characteristics of the liquid fuel gas generation system will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a simplified schematic diagram of an exemplary gas generator system that may be used to implement a liquid rocket propulsion system; and

FIG. 2 is a simplified schematic diagram of an exemplary thrust control system that may use the gas generator system depicted in FIG. 1.

### DETAILED DESCRIPTION OF THE INVENTION

The following detailed description is merely exemplary in nature and is not intended to limit the invention or the application and uses of the invention. Furthermore, there is no intention to be bound by any theory presented in the preceding background or the following detailed description.

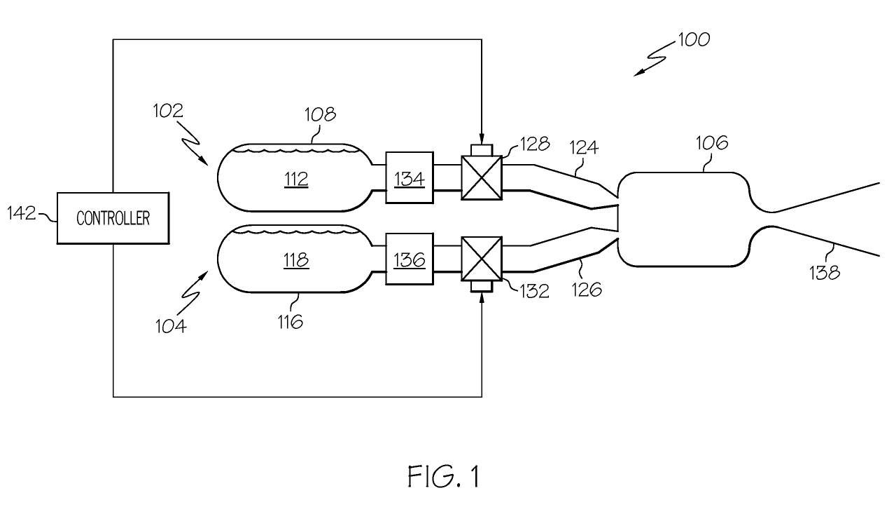

A schematic diagram of an embodiment of a gas generation system 100 is depicted in FIG. 1, and includes a fuel source 102, an oxidizer source 104, and a combustion chamber 106. The fuel source 102 is in fluid communication with, and is operable to supply a flow of liquid fuel to, the combustion chamber 106. The fuel source 102 preferably includes a fuel storage device 108 and a volume of liquid lithium 112. The fuel storage device 108 may any one of numerous suitable containers such as, for example, one or more tanks or one or more bottles. The liquid lithium 112 is disposed within the fuel storage device 108 and, as will be described further below, is selectively supplied to the combustion chamber 106 via one or more fuel modulation valves 114.

The oxidizer source 104 is in fluid communication with, and is operable to supply a flow of oxidizer to, the combustion chamber 106. The oxidizer source 104 preferably includes an oxidizer storage device 116 and a volume of a fluorinated carbon 118. The oxidizer storage device 116 may any one of numerous suitable containers such as, for example, one or more tanks or one or more bottles. The fluorinated carbon 118 is disposed within the oxidizer storage device 116 and, as will also be described further below, is selectively supplied to the combustion chamber 106 via one or more oxidizer modulation valves 122. It will be appreciated that the fluorinated carbon 118 that is used may vary, and may include any one of numerous, common refrigerants, such as R-116 (C₂F₆) and R-218 (C₃F₈), just to name a few.

The combustion chamber 106 is in fluid communication with both the fuel source 102 and the oxidizer source 104. In the depicted embodiment, the combustion chamber 106 is in fluid communication with the fuel source 102 via a first flow passage 124, and in fluid communication with the oxidizer source 104 via a second flow passage 126. The combustion chamber 106 is thus coupled to at least selectively receive a flow of lithium 112 from the fuel storage device 108, and a flow of fluorinated carbon oxidizer 118 from the oxidizer storage device 116. As is generally known, when a fuel and a suitable oxidizer are mixed, potentially high-energy combustion gas can be generated. In the depicted embodiment, the lithium 112 and fluorinated carbon 118 are hypergolic and generate a relatively low molecular weight combustion gas at a temperature of about 5600° F.

The combustion gas that is generated in the combustion chamber 106, which includes a lithium-fluoride (LiF) constituent and a carbon (C) constituent, is non-corrosive to carbon-based materials. Thus, the combustion chamber 106 are formed, or at least partially formed, of a carbon material. It will be appreciated that any one of numerous carbon-graphite or carbon-carbon materials may be used to form, or at least partially form, the combustion chamber 106. In addition, to being non-corrosive to carbon-based materials, the relatively low molecular weight of the generated combustion gas makes it conducive to high thrust specific impulse. Moreover, not only are the lithium 112 and fluorinated carbon 118 non-toxic, so too are the combustion gas constituents.

As was noted above, the liquid lithium 112 and fluorinated carbon 118 are both selectively supplied to the combustion chamber 106. In the depicted embodiment, this is accomplished by means of a pair of modulating valves. More specifically, the depicted system 100 further includes a fuel modulation valve 128 and an oxidizer modulation valve 132 to control the flow of lithium 112 and fluorinated carbon 118, respectively, to the combustion chamber 106. Preferably, the fuel modulation valve 128 and the oxidizer modulation valve 132 are both dual-position, switchable control valves that may be rapidly pulsed between open and closed positions, which provides both high maneuver precision and throttle control.

As FIG. 1 further depicts, the system 100 additionally includes a fuel pump 134 and an oxidizer pump 136. The fuel pump 134 and oxidizer pump 136 may be implemented using any one of numerous suitable pumping devices. For example, each pump 134, 136 may be implemented as a centrifugal fluid pump, a variable speed positive displacement pump, or a pressurized aspirating nozzle. Preferably, as noted above, fuel and oxidizer flow is controlled via the fuel and oxidizer modulation valves 128, 132. It will be appreciated, however, that in alternative embodiments the fuel and oxidizer flow may be controlled via the pumps 134, 136.

No matter the specific manner in which fuel and oxidizer flow are controlled, the combustion gas that is generated in the combustion chamber 106 is used to generate thrust for vehicle propulsion, vehicle attitude control, or both. In the embodiment depicted in FIG. 1, the system 100 is configured as a liquid rocket, which generates the combustion gas for vehicle propulsion. As such, a thrust nozzle 138 is coupled in fluid communication with the combustion chamber 106. The thrust nozzle 138 accelerates and exhausts the combustion gas generated in the combustion chamber 106, thereby generating thrust for vehicle propulsion. Preferably, the thrust nozzle 138 is formed, at least partially, of a carbon material.

The system 100 further includes a controller 142 that is coupled in operable communication with at least the fuel modulation valve 128 and the oxidizer modulation valve 132. The controller 142 may also be coupled in operable communication with the fuel and oxidizer pumps 136, 138, if included. The controller 142 is configured to control the positions of the fuel and oxidizer modulation valves 128, 132. More specifically, and as was alluded to above, the controller 142 rapidly pulses the fuel and oxidizer modulation valves 128, 132 between open and closed positions, to thereby control fuel 112 and oxidizer 118 flow to the combustion chamber 106. As such, combustion gas generation, and thus thrust level, is controlled.

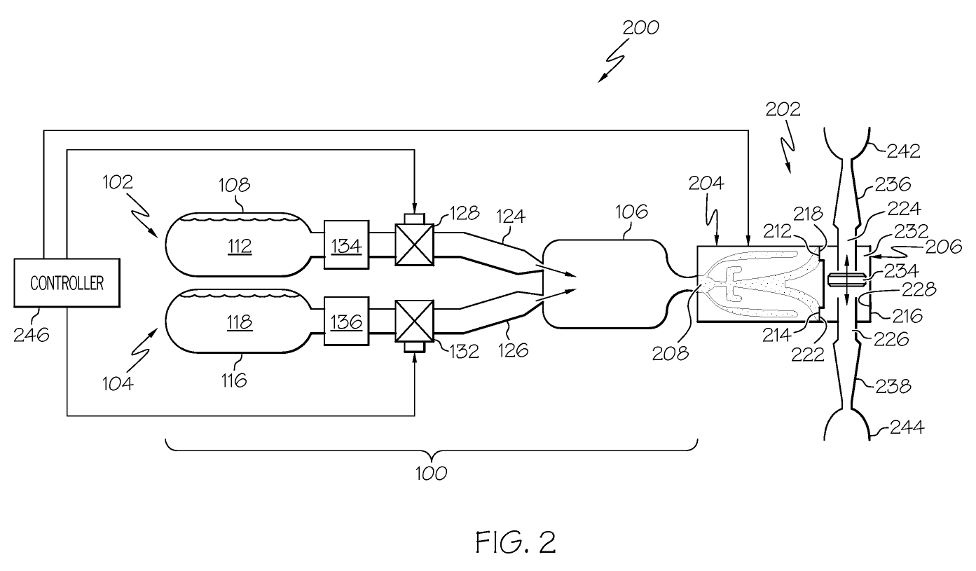

The gas generation system 100 may also be configured for use as part of a thrust control system. An exemplary embodiment of a thrust control system 200 that includes the above-described gas generation system 100 is depicted in FIG. 2, and will now be described. It is noted that like reference numerals in FIGS. 1 and 2 refer to like components, the descriptions of which will not be repeated. The thrust control system 200, in addition to the previously described gas generation system 100, includes a diverter system 202 that is coupled in fluid communication with the combustion chamber 106 to receive the generated combustion gas therefrom. The diverter system 202, an embodiment of which will now be described, is configured to selectively direct the generated combustion gas in one or more axes, to thereby control the attitude of a vehicle.

The diverter system 202, at least in the depicted embodiment, includes a fluidic amplifier 204 and a fluidic diverter valve 206. The fluidic amplifier 204 includes at least a fluid inlet port 208 and two fluid outlet ports, namely a first fluid outlet port 212 and a second fluid outlet port 214. The fluidic amplifier fluid inlet port 208 is coupled in fluid communication with the combustion chamber 106, and the fluidic amplifier first and second fluid outlet ports 212, 214 are coupled in fluid communication with the fluidic diverter valve 204.

The fluidic diverter valve 204 includes a housing 216, a first fluid inlet port 218, a second fluid inlet port 222, and at least two fluid outlet ports, a first fluid outlet port 224 and a second fluid outlet port 226. The housing 216 includes an inner surface 228 that defines a valve element cavity 232, in which a valve element 234 is disposed. The first 218 and second 222 fluid inlet ports and first 224 and second 226 fluid outlet ports each extend through the housing 216, and are each in fluid communication with the valve element cavity 232. The first 218 and second 222 fluid inlet ports are also in fluid communication with the fluidic amplifier first 212 and second 214 fluid outlet ports, respectively. In addition, the fluidic diverter valve first 224 and second 226 fluid outlet ports are in fluid communication with first 236 and second 238 blast tubes, respectively, which are each in fluid communication with first 242 and second 244 thrust nozzles, respectively.

The valve element 234 is translationally moveable, within the valve element cavity 232, between the housing first 226 and second 228 fluid outlet ports. Thus, combustion gas flow to each of the thrust nozzles 242, 244 is controlled by controlling the position of the valve element 234. As is generally known, the position of the valve element 234 is controlled by directing the flow of combustion gas into either the housing first 218 and second 222 fluid inlet ports, which is in turn controlled by controlling combustion gas flow through the fluidic amplifier first 212 and second 214 fluid outlet ports, respectively. Combustion gas flow through the fluidic amplifier first 212 and second 214 fluid outlet ports may be controlled using any one of numerous known devices, methods, and processes for controlling fluid flow in a fluidic amplifier.

Before proceeding further it is noted that the thrust control system 200 depicted in FIG. 2 is a single-axis system. It will be appreciated that, however, that the gas generation system 100 could be used with a multi-axis control system. Moreover, whether implemented in a single- or multi-axis control system, the thrust control system could also be implemented with more than just a single fluidic amplifier, if needed or desired.

As with the embodiment depicted in FIG. 1, the thrust control system 200 further also includes a controller 246. The controller 246 is coupled in operable communication with at least the fuel modulation valve 128, the oxidizer modulation valve 132, and the fluidic amplifier 204. The controller 246 may also be coupled in operable communication with the fuel and oxidizer pumps 136, 138, if included. The controller 246 is configured to control the positions of the fuel and oxidizer modulation valves 128, 132, and to control (via various non-depicted components) combustion gas flow through the fluidic amplifier 204. More specifically, and similar to what was previously described, the controller 246 rapidly pulses the fuel and oxidizer modulation valves 128, 132 between open and closed positions, to thereby control fuel 112 and oxidizer 118 flow to the combustion chamber 106. As such, combustion gas generation, and thus thrust level, is controlled. The controller 246 also controls combustion gas flow through the fluidic amplifier 204, to thereby control the position of the valve element 234, and thus combustion gas flow to the thrust nozzles 242, 244.

It is further noted that those portions of the diverter system 202 that are exposed to the combustion gas are formed, at least partially, of a carbon material. In this regard, at least for the depicted embodiment, the fluidic amplifier 204, the diverter valve 206, the blast tubes 236, 238, and the thrust nozzles 242, 244 are each formed, at least partially, of a carbon material.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A gas generation system, comprising:
a fuel source operable to supply a flow of a lithium fuel;
an oxidizer source operable to supply a flow of a fluorinated carbon oxidizer; and
a combustion chamber, the combustion chamber coupled to receive the flow of lithium fuel and the flow of the fluorinated carbon oxidizer and, upon receipt thereof, to supply a combustion gas, the combustion chamber formed, at least partially, of a carbon material.

2. The system of claim 1, further comprising:
a thrust nozzle in fluid communication with the combustion chamber to receive the combustion gas therefrom.

3. The system of claim 2, wherein the thrust nozzle is formed, at least partially, of a carbon material.

4. The system of claim 1, further comprising:
a fuel modulation valve disposed between the fuel source and the combustion chamber and operable to selectively modulate the flow of the lithium fuel to the combustion chamber; and
an oxidizer modulation valve disposed between the oxidizer source and the combustion chamber and operable to selectively modulate the flow of the fluorinated carbon oxidizer to the combustion chamber.

5. The system of claim 1, further comprising:
a fuel pump disposed between the fuel source and the combustion chamber and operable to draw the lithium fuel from the fuel source and supply the flow of the lithium fuel to the combustion chamber; and
an oxidizer pump disposed between the oxidizer source and the combustion chamber and operable to draw the fluorinated carbon oxidizer from the oxidizer source and supply the flow of the fluorinated carbon oxidizer to the combustion chamber.

6. The system of claim 1, further comprising:
a diverter system in fluid communication with the combustion chamber to receive the combustion gas therefrom.

7. The system of claim 6, wherein the diverter system is formed, at least partially, of a carbon material.

8. The system of claim 6, wherein the diverter system comprises:
a fluidic amplifier having a fluid inlet port and at least two fluid outlet ports, the fluid inlet in fluid communication with the combustion chamber to receive combustion gas therefrom; and
a fluidic diverter valve including:
a housing having a first fluid inlet port, a second fluid inlet port, a first fluid outlet port, a second fluid outlet port, and a valve element cavity formed therein, the first fluid inlet port coupling a first one of the fluidic amplifier fluid outlets in fluid communication with the valve element cavity, the second fluid inlet port coupling a second one of the fluidic amplifier fluid outlets in fluid communication with the valve element cavity, the first and second fluid outlet ports each in fluid communication with the valve element cavity, and
a valve element disposed within the valve element cavity, the valve element moveable in response to combustion gas flow through the inlet ports to move between at least a first position, in which at least a portion of the valve element substantially seals the first fluid outlet port, and a second position, in which at least a portion of the valve element substantially seals the second fluid outlet port.

9. The system of claim 8, wherein the housing and valve element are at least partially formed of a carbon material.

10. The system of claim 8, further comprising:
a first thrust nozzle coupled to the fluidic diverter valve housing and in fluid communication with the housing first fluid outlet port; and
a second thrust nozzle coupled to the fluidic diverter valve housing and in fluid communication with the housing second fluid outlet port.

11. The system of claim 10, wherein the first and second thrust nozzles are formed at least partially of a carbon material.

12. A liquid rocket, comprising:
a fuel source operable to supply a flow of a lithium fuel;
an oxidizer source operable to supply a flow of a fluorinated carbon oxidizer;
a combustion chamber, the combustion chamber coupled to receive the flow of lithium fuel and the flow of the fluorinated carbon oxidizer and, upon receipt thereof, to supply a combustion gas, the combustion chamber formed, at least partially, of a carbon material;
a thrust nozzle coupled to, and in fluid communication with, the combustion chamber to receive the combustion gas therefrom and generate a thrust;
a fuel modulation valve disposed between the fuel source and the combustion chamber and operable to selectively modulate the flow of the lithium fuel to the combustion chamber; and
an oxidizer modulation valve disposed between the oxidizer source and the combustion chamber and operable to selectively modulate the flow of the fluorinated carbon oxidizer to the combustion chamber.

13. The system of claim 12, wherein the nozzle is formed, at least partially, of a carbon material.

14. The system of claim 12, further comprising:
a fuel pump disposed between the fuel source and the combustion chamber and operable to draw the lithium fuel from the fuel source and supply the flow of the lithium fuel to the combustion chamber; and
an oxidizer pump disposed between the oxidizer source and the combustion chamber and operable to draw the fluorinated carbon oxidizer from the oxidizer source and supply the flow of the fluorinated carbon oxidizer to the combustion chamber.

15. The system of claim 12, further comprising:
a controller coupled to the fuel modulation valve and the oxidizer modulation valve and configured to modulate positions thereof to control the generated thrust.

16. A thrust control system, comprising:
a fuel source operable to supply a flow of a lithium fuel;
an oxidizer source operable to supply a flow of a fluorinated carbon oxidizer;
a combustion chamber, the combustion chamber coupled to receive the flow of lithium fuel and the flow of the fluorinated carbon oxidizer and, upon receipt thereof, to supply a combustion gas, the combustion chamber formed, at least partially, of a carbon material;
a fluidic amplifier having a fluid inlet port and at least two fluid outlet ports, the fluid inlet in fluid communication with the combustion chamber to receive combustion gas therefrom; and
a fluidic diverter valve including:
a housing having a first fluid inlet port, a second fluid inlet port, a first fluid outlet port, a second fluid outlet port, and a valve element cavity formed therein, the first fluid inlet port coupling a first one of the fluidic amplifier fluid outlets in fluid communication with the valve element cavity, the second fluid inlet port coupling a second one of the fluidic amplifier fluid outlets in fluid communication with the valve element cavity, the first and second fluid outlet ports each in fluid communication with the valve element cavity, and
a valve element disposed within the valve element cavity, the valve element moveable in response to combustion gas flow through the inlet ports to move between at least a first position, in which at least a portion of the valve element substantially seals the first fluid outlet port, and a second position, in which at least a portion of the valve element substantially seals the second fluid outlet port.

17. The system of claim 16, wherein the housing and valve element are at least partially formed of a carbon material.

18. The system of claim 16, further comprising:
a first thrust nozzle coupled to the fluidic diverter valve housing and in fluid communication with the housing first fluid outlet port; and
a second thrust nozzle coupled to the fluidic diverter valve housing and in fluid communication with the housing second fluid outlet port.

19. The system of claim 16, further comprising:
a fuel modulation valve disposed between the fuel source and the combustion chamber and operable to selectively modulate the flow of the lithium fuel to the combustion chamber; and
an oxidizer modulation valve disposed between the oxidizer source and the combustion chamber and operable to selectively modulate the flow of the fluorinated carbon oxidizer to the combustion chamber.

20. The system of claim 19, further comprising:
a controller coupled to the fuel modulation valve and the oxidizer modulation valve and configured to modulate positions thereof to control the generated thrust.
